(19) United States
(12) Patent Application Publication
(10) Pub. No.: US 2008/0189215 A1
(43) Pub. Date: Aug. 7, 2008

(54) Event driven advertising method and system

(75) Inventors: Italo D. Travez, Ashburn, VA (US); Joe V. Travez, Falls Church, VA (US); Bryan R. Ramos, Ashburn, VA (US)

Correspondence Address: CROWELL & MORING LLP;INTELLECTUAL PROPERTY GROUP, P.O. BOX 14300, WASHINGTON, DC, 20044-4300, US

(73) Assignee: Prototype Productions, Ashburn, VA (US)

(21) Appl. No.: 11/700,959

(22) Filed: Feb. 1, 2007

(51) Int. Cl. G06Q 30/00

(52) U.S. Cl. 705/80; 725/32

(57) ABSTRACT

A method and system of generating advertising revenue. Bids are received for advertisements based on the potential occurrence of an event. The highest bidder's advertisement is displayed upon the occurrence of the event. The advertisement may be displayed on a television viewer's screen, at the location of the event or on the person performing the event. Bids can also be received for advertisements based on the actual occurrence of an event.

### BACKGROUND

Television advertising is a huge business. Companies are willing to pay large sums of money to get their name or product on the television because they know that millions of people may be watching the same telecast at a particular point in time. For instance, the audience for the some sporting events such as the Super Bowl is on the order of one hundred million viewers in over two hundred countries. Thus, television advertising offers the capability of reaching a large audience over a wide variety of markets.

Traditional advertising involves commercials that are displayed on the television at specified times such as when there is a break in the action of a sporting event. Companies also pay money for product or name placement within the telecast itself. For example, a company may pay the telecaster of a sporting event such a boxing contest for the placement of the company's logo in the middle of the boxing ring. Thus, viewers who are watching the fight will be forced to see the logo as opposed to the possibility of a commercial being aired between rounds which the viewer may miss.

With the development of recent technology, it is now possible for companies to purchase virtual advertising during telecasts such as sporting events. For example, instead of an actual logo being displayed in the middle of the boxing ring an image of the logo is superimposed over the telecast so the viewer sees the logo but spectators at the event do not see the logo. This technology allows the broadcaster to change the logo throughout the sporting event. For example, in a given baseball telecast the displayed banners behind home plate routinely change with every pitch. Thus, the broadcaster can offer advertising time to a greater number of companies for a shorter period of time resulting in a higher revenue stream than would result from a single company purchasing the advertising space behind home plate for the duration of the game.

However, there is an even greater potential for advertising that has thus far remained untapped. The instant invention provides a method of advertising based on the actual action of a sporting event.

### SUMMARY

One embodiment of the present invention is a method of selling advertising for a sporting event. In one step, at least one possible outcome of the sporting event is determined. Bids are then received for at least one advertisement to be displayed at the time of the at least one possible outcome. The highest bidder is then selected at sometime before the at least one possible outcome occurs. The advertisement of the highest bidder is then displayed at the time of the at least one possible outcome if the outcome occurs.

Another embodiment of the invention is a system for advertising for a sporting event. One portion of the system includes means for generating at least one possible outcome of the sporting event. Another part of the system includes means for receiving bids for at least one advertisement to be displayed at the time of the occurrence of the at least one possible outcome. The system also includes means for selecting the highest bidder at some time before the occurrence of the at least one possible outcome. Another portion of the system includes means for displaying the advertisement of the highest bidder at the time of the occurrence of the at least one possible outcome.

A further embodiment of the instant invention encompasses a real time auction in which bidders bid on advertisement placement.

An additional embodiment of the instant invention encompasses a real time auction in which bidders bid on advertisement timing.

Yet another embodiment of the instant invention encompasses a real time auction in which bidders bid on the type of advertising (logo, number of characters, audio, etc.)

### BRIEF DESCRIPTION OF THE DRAWINGS

FIG. 1 shows a flow chart depicting three different alternative systems for advertising in accordance with one embodiment of the invention.

FIG. 2 shows an athletic jersey in accordance with one embodiment of the invention.

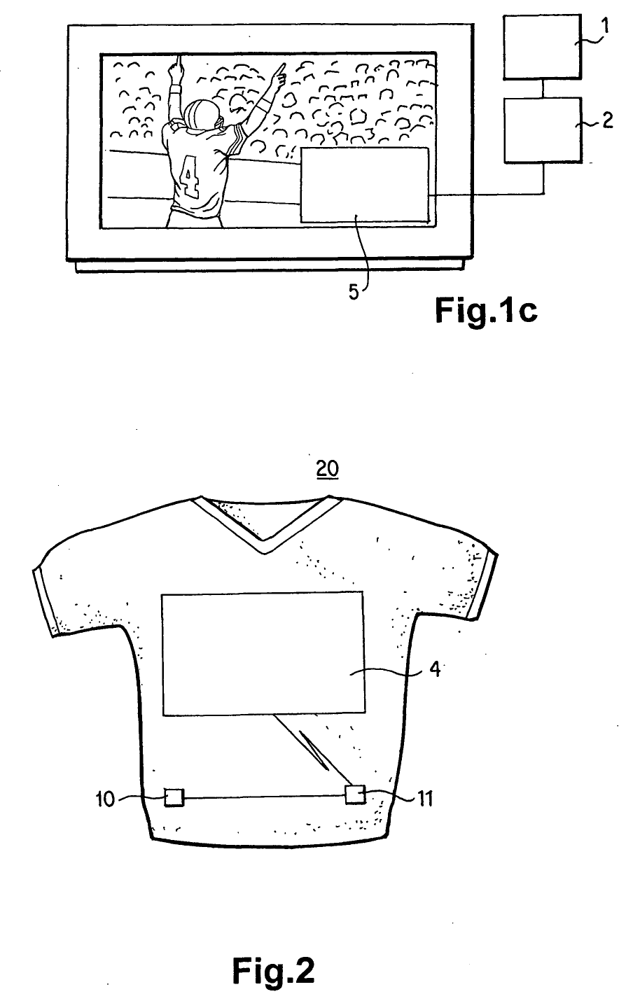

FIG. 3 shows real and virtual advertisement displays in accordance with one embodiment of the invention.

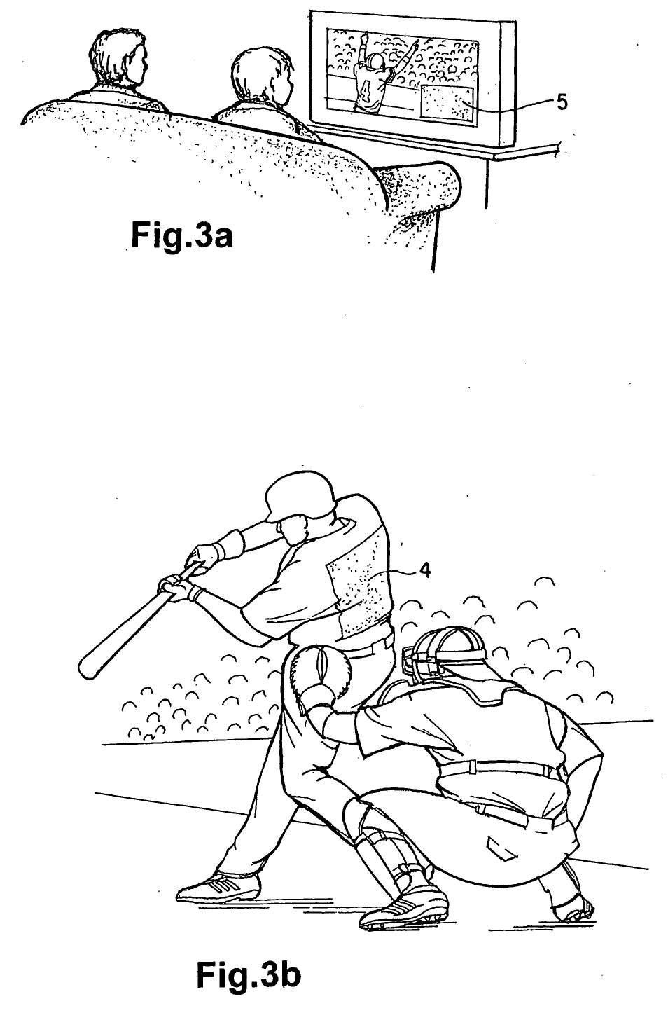

FIG. 4 shows an automatically triggered advertisement in accordance with one embodiment of the invention.

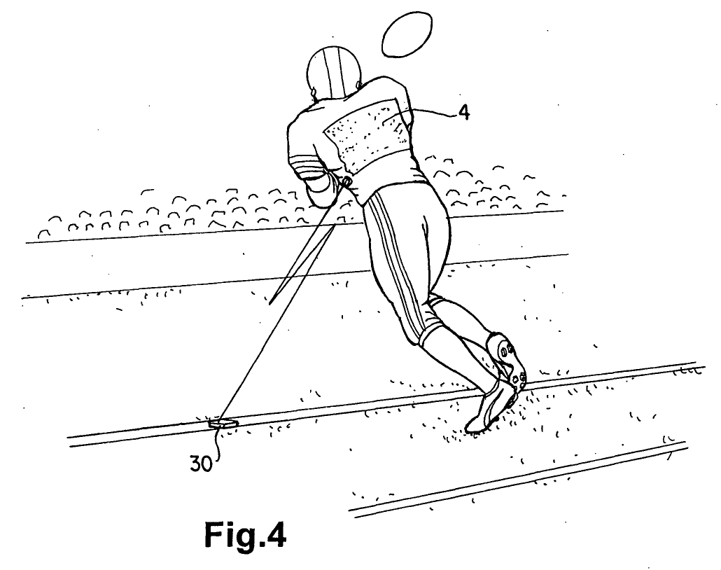

### DESCRIPTION

One embodiment of the instant invention is a method of selling advertisements for a televised sporting event. The method includes the step of determining a number of sport specific outcomes. The next step is determining a number of event-specific possible outcomes or results. Bids are then received for the display of an advertisement based on each possible event-specific outcome. The highest bid is then chosen at some time before the occurrence of the event-specific outcome. The advertisement of the highest bidder is then displayed at the time of the occurrence of the event-specific outcome. The highest bidder is then charged for the advertisement.

The step of determining a number of sport-specific outcomes can be performed by analyzing the different likely events in any given sport. For example, one likely event in the sport of football is the scoring of a touchdown. The step of determining a number of event-specific possible outcomes from the list of sport-specific outcomes can be performed by human operator or statistical analysis. For example, any player that is expected to play in any particular football game could statistically score a touchdown. Therefore, the event-specific outcomes related to the sport-specific outcome of the scoring of a touchdown could be any player on either team scoring a touchdown. Of course, it may not be necessary to receive bids on all of these possible event-specific outcomes. For example, the operator could determine which players are the ten most likely to score on each team and then receive bids just on these event-specific outcomes. The generation of the most likely event-specific outcomes could also be done by statistical analysis. For example, a computer could statistically determine who are the ten most likely players on each team to score a touchdown based on past performance such as average touchdowns per game, average number of plays touching the ball, average number of plays from the line of scrimmage, etc.

The list of possible event-specific outcomes could then be posted for potential bidders to bid on. The outcomes could be posted by any method on any medium. Preferably, the outcomes are posted on a website. Auction based websites are well known in the art and therefore not described in detail here. Alternatively, the event-specific outcomes could be posted to a specific group of people. For example, the outcomes could be displayed in an auction room by any method.

The method of receiving bids can include any known method. For example, bids could be received over the internet by the bidder interfacing with the website displaying the possible event-specific outcomes. Bids could also be received orally or silently in the auction room or via telephone.

The highest bid could be chosen by a human operator at some time before the actual outcome occurs. For example, if the event-specific outcome is a certain player returning an interception for a touchdown then the highest bidder could be chosen at the moment the player intercepts a ball. Alternatively, the highest bidder could be chosen at any time before the actual outcome occurs including before the start of the event.

Bids may also be received on sport-specific outcomes. For example, in the case of football bids could be received on a game winning touchdown. In this embodiment, the highest bidder could be chosen before the start of the game. Of course bids could also be received throughout the span of the event because depending on the type of game the value of an advertisement related to a game winning touchdown may change.

The present invention is not limited to advertising for live sporting events. Other applications include news broadcasts. In this embodiment, bids could be received based on the occurrence of an event. For example, if there was a graphic murder of someone while they were in their home, bids could be received for advertisements to be broadcast after the news item was reported. Bids could be only offered to a limited industry or could be open to everyone. In this example, it would be expected that home security companies would be interested in advertising their products and services in relation to the graphic murder.

The advertisement may be displayed by any manner. For example, the advertisement may just be a virtual banner that is displayed on the viewer's television screen when the event occurs. In the case of football, the advertisement could be a virtual sign behind the end zone that displays the highest bidder's company name or logo as the player is crossing the goal line. In this example, the display could be integrated into the telecast in the usual manner that virtual advertisements are added to broadcasts. This technology is generally known as blue screen technology. An image is superimposed over the live camera shot so that the image appears to be part of the shot to the television viewer. Of course, the advertisement could also just be a traditional television advertisement that would be broadcast at some time after the event occurred. For example, if a bid were received for a sport-specific event such as game tied pitching change in the ninth inning of the baseball game, the advertisement displayed could just be a traditional advertisement shown at the regularly scheduled break during the time for the relief pitcher to enter the game from the bullpen.

In another embodiment, the display could occur on the field itself, such as a football field. In this embodiment, for example, when a player scored a touchdown the winning bidder's advertisement could be displayed in the end zone. In this embodiment, the display could be formed by transmitting an advertisement to the field or by manipulating the grass strands making up the field.

In another embodiment, the display could occur on the athlete associated with the sport-specific or event-specific outcome. For example, as a player is crossing the goal line, the highest bidder's company logo could be displayed on the back of the player's jersey. In a further embodiment, the display could occur on the playing field or in the venue in which the event occurs. For example, upon a player crossing the goal line in a football game, the end zone could display the winning bidder's advertisement.

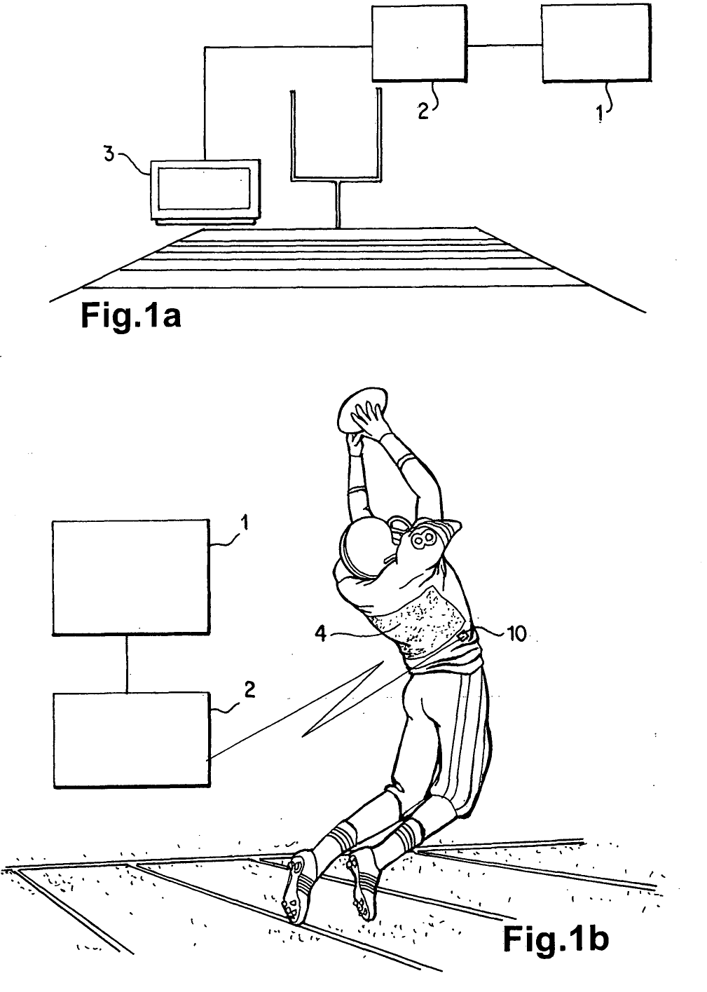

FIG. 1 shows three alternative systems for advertising. In each system a bidder 1 sends a bid to a control center 2. The control center then determines who the winning bidder is and sends an advertisement signal to a display means. In FIG. 1a, the advertisement is sent to a display means 3 that can be seen by a live audience at a sporting event such a display in the end zone of a football field. FIG. 1b shows an alternative embodiment where the display 4 is located on a players jersey. In this embodiment, receiving means 10 receives the signal from the control center 2 and causes the advertisement to be shown on display means 4. In another embodiment, the advertisement is only visible to a television or other medium viewing audience. In this embodiment, control center 2 causes the advertisement to be shown in display means 5

One example of where this embodiment could be implemented is a telecast of a golf major tournament. For example, a list of golf specific outcomes could be generated including the approach shot to the eighteenth green on the final day of the tournament. A list of tournament-specific outcomes could then be generated for each golf specific outcome. For example, the approach shot to the eighteenth green of each player who made the cut. Bids could then be received for an advertisement associated with each player's approach shot to the eighteenth hole. At some time before each player's approach shot the highest bidder for each player could be chosen. For example, the highest bidder could be chosen at the time of each player's tee shot on eighteen.

As each player hit their approach shot on eighteen the event-specific outcome highest bidder's advertisement would be displayed. For example, the advertisement could be displayed on the back of the player's shirt or hat. This advertisement could be a virtual advertisement only visible to the television viewer or could be a real advertisement visible to the live audience as well as the television viewer.

In the embodiment where a real advertisement is displayed on the athlete's clothing, the athlete could be equipped with a wireless receiver, computer and a display device. A signal could be sent to the wireless receiver and the computer could cause the highest bidder's advertisement to be shown on the display device.

In one embodiment, the display device may just be a flexible LCD screen. For example, such a screen could be integrated into a golfer's hat. Upon receiving a signal, the computer could then cause the highest bidder's logo to be displayed on the LCD screen. The display could also be an electronic paper flexible display comprising electronic ink. In this technology, the ink comprises millions of microcapsules. Each microcapsule comprises positively charged white particles and negatively charged black particles. By applying an electric field to the ink, the particles can be arranged to create any shape or display. One example of electronic paper display technology is disclosed in U.S. Pat. No. 6,922,276, assigned to E Ink Corporation which is hereby incorporated by reference in its entirety. In this embodiment, the electronic ink could be printed directly on the athlete's apparel or a flexible screen containing the electronic ink could be attached to the player's apparel.

In another embodiment, the athlete's apparel could actually be made of material that allowed the advertisement to be displayed. In this embodiment, the clothing could be composed entirely or partially of “smart cloth.” Smart clothing generally is clothing that combines traditional textiles with information technology, permitting electronic devices to be attached or embedded within the clothing. The most advanced type of smart clothing is used in military camouflage. The type of smart clothing used will depend on the particular sporting event. For instance, a very light-weight and durable smart cloth may not be necessary for the sport of golf but would be for an action sport such as football.

This embodiment could be especially lucrative for advertising in action sports. For example, in a football game such as the Super Bowl, bids could be taken for displaying an advertisement on the back of a certain player's jersey should that player score a game winning touchdown. In this embodiment, as the player was crossing the goal line, the highest bidder's logo could be displayed on the player's jersey for all the viewers to see.

Published U.S. Patent Application No. 3003/0224621, which is hereby incorporated by reference in its entirety, describes one type of smart clothing that includes organic light emitting diodes integrated into the fabric that can display information. The fabric may also contain wireless devices that allow for communication. Published U.S. Patent Application No. 2003/0090598, which is hereby incorporated by reference in its entirety, describes one example of fabric that could be used in the present invention.

The present invention is not limited to any kind of display or communication system. The general system embodied by the present invention includes a business control center and a display. The business control center may consist of at least one computer and at least one person. The center will post possible advertisements for sale in an auction format. The center will then receive bids for each particular event-driven advertisement from potential advertisements. At some time before the actual occurrence of the event, the center will choose the highest bid. At the time of the actual event, the center will communicate with the display and cause the winning bidder's advertisement to be shown simultaneously with the occurrence of the event on the display.

The communication between the business control center and the display device may occur by any method. For example, the business control center could send a wireless signal to a wireless antenna integrated into an athlete's apparel. The computer processing unit integrated into the apparel could then cause the display integrated into the apparel to display the winning bidder's advertisement such as a company symbol. Of course any other method of communication is also within the scope of the present invention.

The advertisement could also be pre-programmed into the CPU integrated into the athlete's clothing. For example, if a highest bidder for a certain player scoring a touchdown in the last five minutes of a game was chosen with six minutes left in the game, a signal could be sent to the CPU programming it to cause the advertisement to be displayed when the player crosses the one yard line. In this embodiment, a global positioning system (GPS) device could also be integrated into the athlete's apparel enabling the CPU to know exactly when the one yard line was reached. The GPS device could be located anywhere on the athlete such as in the athlete's helmet or integrated into the athlete's jersey. Alternatively, the advertisement display could be triggered by a transmitting means buried under the field. In this embodiment, a receiver located on the player's apparel could receive a signal transmitted from the buried transmitting means that would trigger a CPU located on the player's apparel to display the advertisement on the display means.

In the embodiment where a virtual advertisement is displayed, all actions could be performed from the business control center. In this embodiment, after the highest bidder was chosen, the business control center could cause the winning bidder's advertisement to be displayed on the viewer's screen at the appropriate time.

Although only visual advertisements have been described herein, the invention is not so limited. Any advertisement could of course be accompanied by audio. Moreover, in the same way parties could bid for their advertisement to be shown at the time of the occurrence of a particular event, parties could also bid for their advertisement to be heard at the time of the event.

The present invention is not limited to the television medium. Other media that the present invention is applicable to include cellular phones, computers and other portable electronic devices. For example, bids could be received on an advertisement to be sent to a cellular phone upon the occurrence of an event. For example, bids could be received on an advertisement to be displayed after a home run by a popular player in a baseball game. Upon the player hitting a homerun, the winning bidder's advertisement could be sent to cellular phone subscribers, followed by the textual, visual, or audio report of the home run.

Although certain embodiments have been described to illustrate the instant invention, the invention is not meant to be limited in any way to these specific embodiments. Furthermore, the invention is not meant to be limited in any way to specific materials or devices. Any known methods or devices can be used to determine possible events to bid on, post and receive bids, determine a geographical position, or cause the winning bidder's advertisement to be displayed at a certain location or certain time. Although the present invention has been described for use at sporting events, it is not meant to be limited to such use. Other possible applications include music performances, parades, speeches, or any event that has a live or television or other media audience.

What is claimed is:

1. A method of selling advertising for a sporting event, said method comprising:
generating at least one possible outcome;
receiving bids for at least one advertisement to be displayed at the time of the at least one possible outcome;
selecting the highest bidder at sometime before the at least one possible outcome; and
displaying the advertisement of the highest bidder at the time of the at least one possible outcome if the outcome occurs.

2. The method of claim 1 wherein the step of displaying the advertisement comprises displaying a virtual advertisement that is visible to the television viewer but not the live audience.

3. The method of claim 1 wherein the step of displaying the advertisement comprises displaying an advertisement at the actual location of the sporting event.

4. The method of claim 3 wherein the step of displaying the advertisement comprises displaying an advertisement on the apparel of a participant in the sporting event.

5. A system for advertising for a sporting event, said system comprising:
means for generating at least one possible outcome;
means for receiving bids for at least one advertisement to be displayed at the time of the at least one possible outcome;
means for selecting the highest bidder at some time before the occurrence of the at least one possible outcome;
means for displaying an advertisement of the highest bidder at the time of the at least one possible outcome.
